(19) United States
(12) Patent Application Publication
(10) Pub. No.: US 2021/0240231 A1
(43) Pub. Date: Aug. 5, 2021

(54) HINGE ASSEMBLIES WITH ELASTIC MEMBERS

(71) Applicant: Hewlett-Packard Development Company, L.P., Spring, TX (US)

(72) Inventors: Chung Hua Ku, Taipei City (TW); Yung Yun Chen, Taipei City (TW); Hung-Sung Pan, Taipei City (TW)

(73) Assignee: Hewlett-Packard Development Company, L.P., Spring, TX (US)

(21) Appl. No.: 17/054,665

(22) PCT Filed: Oct. 9, 2018
(86) PCT No.: PCT/US2018/054901

§ 371 Date: Nov. 11, 2020

(51) Int. Cl. G06F 1/16

(52) U.S. Cl. CPC G06F 1/1681; G06F 1/1618

(57) ABSTRACT

In one example, a hinge assembly may include a support structure, a shaft received through the support structure, and a torque mechanism to apply a frictional torque to the shaft. Further, the hinge assembly may include a first bracket and a second bracket. The shaft may be fixedly engaged with the first bracket to pivotably connect the first bracket to the second bracket. The first bracket may include a recess portion and an edge portion. Furthermore, the hinge assembly may include an elastic member rotatably mounted on the shaft. The elastic member may include a first end fixed to the support structure and a second end positioned in the recess portion such that the elastic member is in a free state while moving in the recess portion and in an energy storage state when engages with the edge portion during rotation of the first bracket relative to the second bracket.

### BACKGROUND

Electronic devices such as laptop computers, tablet, computers, convertible devices, mobile phones, and the like may include a main housing, a display housing, and a hinge assembly mounted between the main housing and the display housing. For example, the main housing may house a keyboard, a motherboard, and/or other components. The display housing may house a display. The hinge assembly may connect the display housing to the main housing and allow the display housing to rotate relative to the main housing.

### BRIEF DESCRIPTION OF THE DRAWINGS

Examples are described in the following detailed description and in reference to the drawings, in which:

FIG. 1A is a schematic view of an example hinge assembly, depicting an elastic member mounted on a shaft;

FIG. 1B is a schematic view of the example hinge assembly of FIG. 1A, depicting additional features;

FIGS. 2A to 2D are schematic side views of a portion of the example hinge assembly of FIG. 1A, illustrating an energy storage state and a free state of the elastic member at different angles of rotation;

FIG. 3 is a schematic view of an example dual-axis hinge assembly, depicting an elastic member mounted on a first shaft;

FIG. 4 is an exploded view of the example dual-axis hinge assembly of FIG. 3, depicting additional features;

FIG. 5 is a side view of the example dual-axis hinge assembly of FIG. 3;

FIGS. 6A to 6D are schematic views of the example dual-axis hinge assembly of FIG. 3, illustrating an example operation of the elastic member at different angles of rotation;

FIG. 7 is an example graph depicting an overall torque of the hinge assembly of FIG. 3 at particular angles of rotation;

FIG. 8 is a perspective view of a portion of an example electronic device including an example hinge assembly; and

FIG. 9 is a perspective of the example hinge assembly of FIG. 8, depicting additional features.

### DETAILED DESCRIPTION

Hinged electronic devices, such as laptop computers, tablet computers, personal digital assistants (PDAs), and flip mobile phones, may include a main housing and a display housing connected by a hinge assembly. The display housing may include a display (e.g., a touchscreen display). The main or base housing may include input devices, such as a keyboard, a pointing stick, mouse buttons, a touchpad, a trackpad, and/or the like. The display housing may be attached to the main housing such that the display housing can be moved and/or rotated (e.g., between 0 to 360 degrees) with respect to the main housing along a single-axis or dual-axis to hold the display at multiple positions. To achieve such rotation, the display housing can be attached to the main housing using the hinge assembly that allows the display housing to be rotated relative to the main housing.

For example, the hinge assembly may incorporate a friction mechanism that provides a frictional force to hold the display housing at multiple positions. The frictional force in the hinge assembly that supports the weight of the display housing may be significant that two hands may be involved to open the electronic device, i.e., one hand to hold the main housing while the other hand to pivot the display housing about the hinge assembly. Furthermore, the weight of the display housing may have a tendency to slam closed against the main housing, for instance, as the friction hinge weakens over time. Therefore, a higher torque may be needed to support a hinge up weight (i.e., a display housing weight) for no free down, while a lesser torque may be needed to support one hand or light weight opening of the electronic device.

Examples described herein may provide a hinge assembly for an electronic device. The hinge assembly may include a shaft fixedly engaged with a first bracket to pivotally connect the first bracket to a second bracket. The first bracket may include a recess portion and an edge portion. Further, the hinge assembly may include an elastic member rotatably mounted on the shaft. The elastic member may include a first end fixed to a support structure and a second end positioned in the recess portion such that the elastic member is in a free state while moving in the recess portion and in an energy storage state when engages with the edge portion during rotation of the first bracket relative to the second bracket.

Examples described herein may utilize the released and stored energy of the elastic member during the opening and closing process of the electronic device at specific angle ranges. Thus, examples described herein may realize the feeling of “opening the light and closing the weight” in the opening and closing process of the electronic device, and thereby enhancing the user experience.

In the following description, for purposes of explanation, numerous specific details are set forth in order to provide a thorough understanding of the present techniques. It will be apparent, however, to one skilled in the art that the present apparatus, devices and systems may be practiced without these specific details. Reference in the specification to “an example” or similar language means that a particular feature, structure, or characteristic described may be included in at least that one example, but not necessarily in other examples.

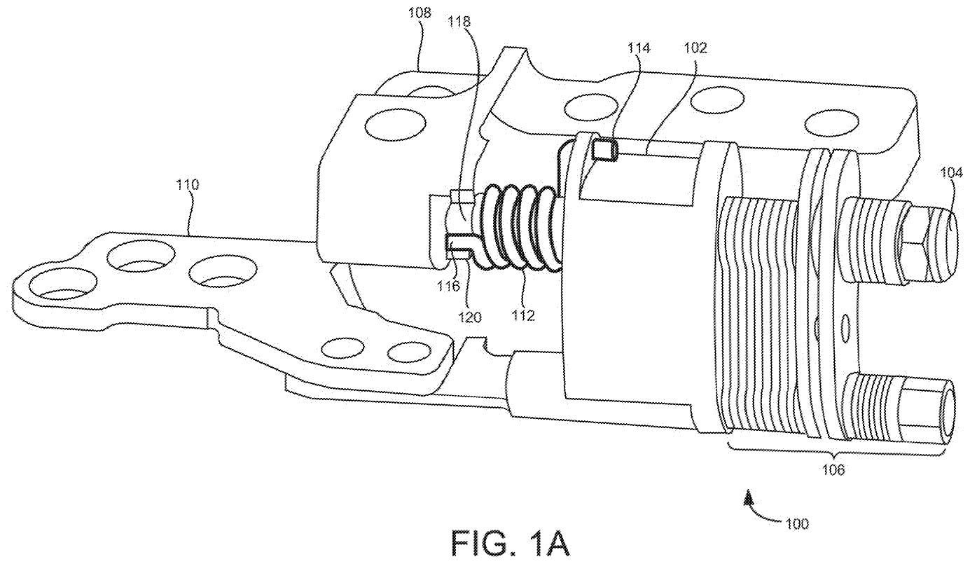

Referring now to the figures, FIG. 1A is a schematic view of an example hinge assembly 100, depicting an elastic member 112 mounted on a shaft 104. Example hinge assembly 100 may be a single-axis hinge assembly or a dual-axis hinge assembly. Hinge assembly 100 may pivotally connect a first housing to a second housing along a single-axis or a dual-axis. Hinge assembly 100 may include a support structure 102, shaft 104 received through support structure 102, and a torque mechanism 106 to apply a frictional torque to shaft 104.

Further, hinge assembly 100 may include a first bracket 108 and a second bracket 110. In one example, shaft 104 may be fixedly engaged with first bracket 108 to pivotably connect first bracket 108 to second bracket 110. Further, first bracket 108 may include a recess portion 118 and an edge portion 120. In one example, first bracket 108 may engage with the first housing of an electronic device and second bracket 110 may engage with the second housing of the electronic device. Example first housing may be a display housing and example second housing may be a base or main housing.

Furthermore, hinge assembly 100 may include elastic member 112 rotatably mounted on shaft 104. In one example, elastic member 112 may include a first end 114 fixed to support structure 102 and a second end 116 positioned in recess portion 118. In one example, elastic member 112 may be in a free state while moving in recess portion 118 and in an energy storage state when engages with edge portion 120 during rotation of first bracket 108 relative to second bracket 110.

FIG. 1B is a schematic view of example hinge assembly 100 of FIG. 1A, depicting additional features. For example, similarly named elements of FIG. 1B may be similar in structure and/or function to elements described with respect to FIG. 1A. Example first bracket 108 may include an adaptor portion 152 to fixedly hold shaft 104 and a mounting portion 154 to fixedly engage with the first housing of the electronic device. In one example, recess portion 118 and edge portion 120 may be formed on an outer surface of adaptor portion 152.

During operation, elastic member 112 may apply a rotational torque to shaft 104 between a particular angle of rotation of first bracket 108 relative to second bracket 110. Example elastic member 112 may be a torsion spring. Further, the particular angle of rotation may correspond to the energy storage state. For example, the particular angle of rotation may be in a range of 0 to 30 degrees. In one example, the rotational torque may add to the frictional torque in a first rotational direction of first bracket 108 and resist the frictional torque in a second rotational direction of first bracket 108. The second rotational direction may be opposite to the first rotational direction. For example, the first rotational direction may correspond to closing of the electronic device and the second rotational direction may correspond to opening of the electronic device. In one example, the particular angle of rotation corresponding to the energy storage state may be controlled based on a location of edge portion 120.

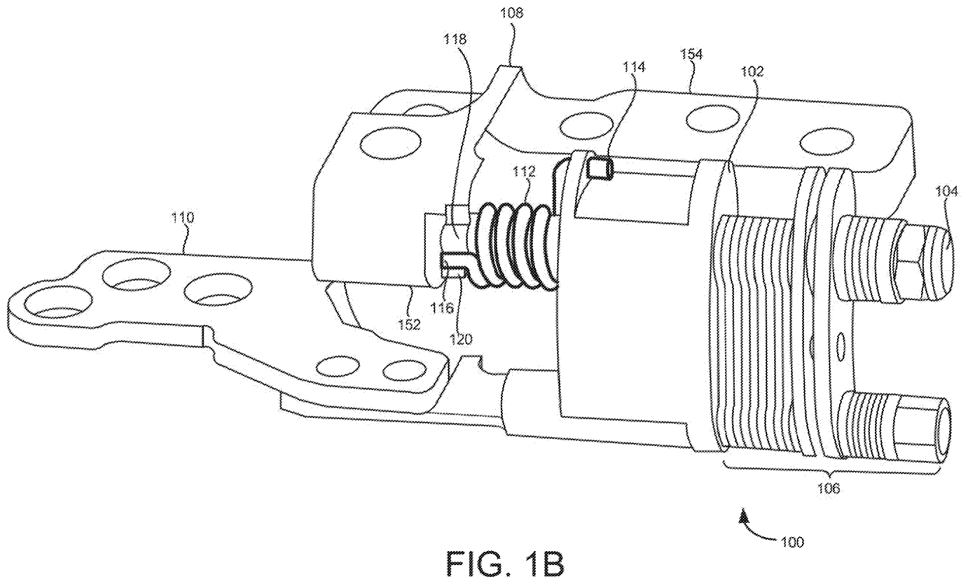

Example hinge assembly 100 described herein may provide variable torque at different angles of rotation of the first housing relative to the second housing. For example, during closing of the electronic device, hinge assembly 100 may provide an additional torque at a specific angle (e.g., 0-30 degrees) to support a hinge up weight (e.g., a first housing weight) for no free down and also provide a lesser torque at the specific angle for the hinge up one-hand open via torsion of elastic member 112 at the specific angle. The operation of hinge assembly 100 at different angles of rotation is described in FIGS. 2A to 2D.

FIGS. 2A to 2D are schematic side views of a portion of example hinge assembly 100 of FIG. 1A, illustrating an energy storage state and a free state of elastic member 112 at different, angles of rotation. For example, similarly named elements of FIGS. 2A-2D may be similar in structure and/or function to elements described with respect to FIG. 1A. Example first bracket 108 may engage with the first housing of the electronic device and second bracket 110 may engage with the second housing of the electronic device.

In one example, elastic member 112 may be in the free state or in the energy storage state depending on an angle of rotation between first bracket 108 and second bracket 110. At 180 degrees as shown in FIG. 2A, second end 116 of elastic member 112 may be positioned in recess portion 118. In this case, elastic member 112 may be in the free state. When first bracket 108 is rotated from 180 degrees to 90 degrees with respect to second bracket 110 as shown in FIG. 26, second end 116 may slide on recess portion 118 of first bracket 108. In this example, elastic member 112 may be in the free state. Further, when first bracket 108 is rotated from 90 degrees to 30 degrees as shown in FIG. 2C, second end 116 may begin to contact with edge portion 120 of first bracket 108 and elastic member 112 may start to compress.

When first bracket 108 is rotated from 30 degrees to 0 degrees as shown in FIG. 2D, edge portion 120 may push second end 116 such that elastic member 112 may get compressed to generate the rotational force in the opposite direction. Thus, from 30 degrees to 0 degrees, elastic member 112 may be in the energy storage state. In one, example, during opening of the electronic device, the elastic potential energy (i.e., the stored energy) may be converted into the rotational kinetic energy the rotational force) of elastic member 112 to assist in opening of the electronic device so that the force required for opening may be light. Thus, elastic member 112 may generate rotational/opening force, which may cause the first housing to open relative to the second housing, and hence opening of the electronic device may become light and a user can open the first housing of the electronic device with one hand.

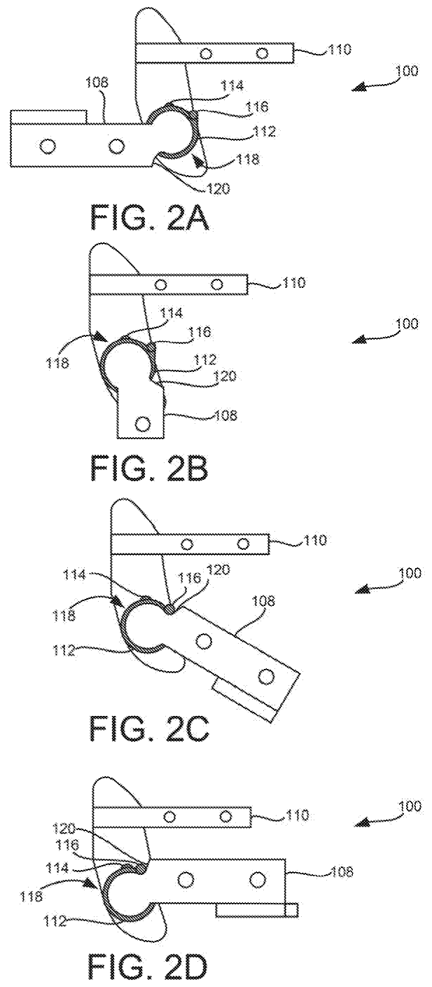

FIG. 3 is a schematic view of an example dual-axis hinge assembly 300, depicting an elastic member 318 mounted on a first shaft 310. Dual-axis hinge assembly 300 may pivotally connect a first housing to a second housing of the electronic device along two axes. Example dual-axis hinge assembly may include a first bracket 302 and a second bracket 304 to connect to the first housing and the second housing, respectively. Example first housing may be a display housing and example second housing may be a base housing or vice versa. In one example, first bracket 302 may include a recess portion 306 between a first edge 308A and second edge 308B.

Further, dual-axis hinge assembly 300 may include first shaft 310 coupled to first bracket 302, a second shaft 312 coupled to second bracket 304, and a torque engine 314 connected to first shaft 310 and second shaft 312. Furthermore, dual-axis hinge assembly 300 may include a synchronous gear unit 316 disposed between first shaft 310 and second shaft 312. Also, dual-axis hinge assembly 300 may include elastic member 318 rotatably mounted on first shaft 310. Example elastic member 318 may be a torsion spring. In some examples, elastic member 318 may have other structure and configurations while ensuring the function of elastic member 318.

In one example, elastic member include a fixed end 320 and a movable end 322 positioned in recess portion 306. For example, fixed end 320 may be connected to a stationary portion of dual-axis hinge assembly 300. During, operation, elastic member 318 may be in a free state while moving in recess portion 306 and in an energy storage state when engages with first edge 308A or second edge 308B during rotation of first bracket 302 relative to second bracket 304.

In one example, movable end 322 of elastic member 318 may engage with first edge 308A during closing of first bracket 302 relative to the second bracket 304 such that elastic member 318 may generate a first spring torque to dual-axis hinge assembly 300 between a first angle range. For example, the first angle range may be in a range of about 30 to 0 degrees. Further, movable end 322 may engage with second edge 308B during opening of first bracket 302 relative to second bracket 304 such that elastic member 318 may generate a second spring torque to dual-axis hinge assembly 300 between a second angle range. For example, the second angle range may be in a range of about 330 to 360 degrees. In one example, elastic member 318 may resist the, torque generated by torque engine 314 at specific angles (e.g., while opening from 0 to 30 degrees or rotating from 360 to 330 degrees) to realize light opening of the electronic device.

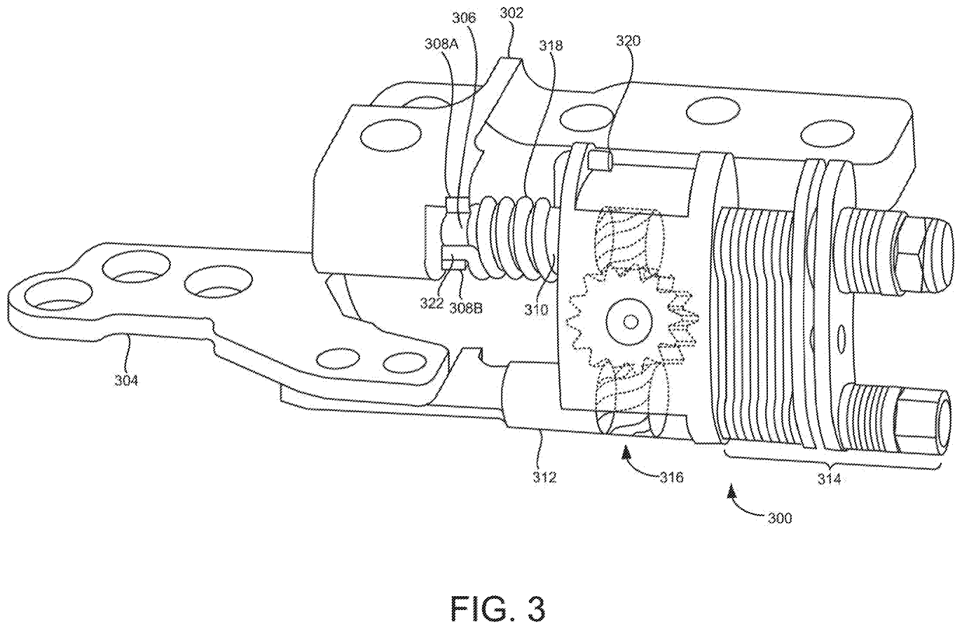

FIG. 4 is an exploded view of example dual-axis hinge assembly 300 of FIG. 3, depicting additional features. For example, similarly named elements of FIG. 4 may be similar in structure and/or function to elements described with respect to FIG. 3. As shown in FIG. 4, first bracket 302 may include a mounting portion 402 to fixedly engage with the first housing and an adaptor portion 404 to fixedly hold first shaft 310. In one example, recess portion 306 may be formed on an outer surface of adaptor portion 404.

As shown in FIG. 4, synchronous gear unit (e.g., synchronous gear unit 316 as shown in FIG. 3) may include a first guide threaded portion 406 on first shaft 310, a second guide threaded portion 408 on second shaft 312, and an intermediate gear 410 to engage with first guide threaded portion 406 and second guide threaded portion 408. In one example, intermediate gear 410 may enable synchronous rotation between first shaft 310 and second shaft 312 in reverse directions. Further, synchronous gear unit 316 may include a gear holder 412 to hold intermediate gear 410 such that intermediate gear 410 may physically engage with first guide threaded portion 406 and second guide threaded portion 408. In one example, synchronous gear unit 316 may synchronously rotate hinge up and hinge base shafts (e.g., first shaft 310 and second shaft 312). Further, synchronous gear unit 316 may include a casing 414 to receive first guide threaded portion 406, second guide threaded portion 408, and intermediate gear 410. In one example, gear holder 412 may hold intermediate gear 410 in casing 414 through an opening 416 defined in a side wall of casing 414. Example casing 414 may be made up of a metallic substance, plastic material, fiber-based material, polymer material, and the like. In other examples, synchronous gear unit 316 may include any other structure that provides synchronous rotation between first shaft 310 and second shaft 312 in reverse directions.

Example torque engine 314 may include torque plates 418 and clip torque engine 428 (e.g., convex plates) to connect first shaft 310 and second shaft 312, frictional plates 422A and 422B, spring washers 420A and 420B (e.g., disc springs), and spacers 424A and 424B disposed on respective one of first shaft 310 and second shaft 312 to provide frictional resistance to hinge assembly 300. In one example, first shaft 310 and second shaft 312 may be rotatably inserted into respective ones of torque plates 418, clip torque engine 428, frictional plates 422A and 422B, spring washers 420A and 420B, and spacers 424A and 424B. Also, torque engine 314 may include fasteners 426A and 4268 secured to an end of first shaft 310 and second shaft 312, respectively. In other examples, torque engine 314 may include any other structure such that torque engine 314 may provide frictional resistance between first shaft 310 and second shaft 312.

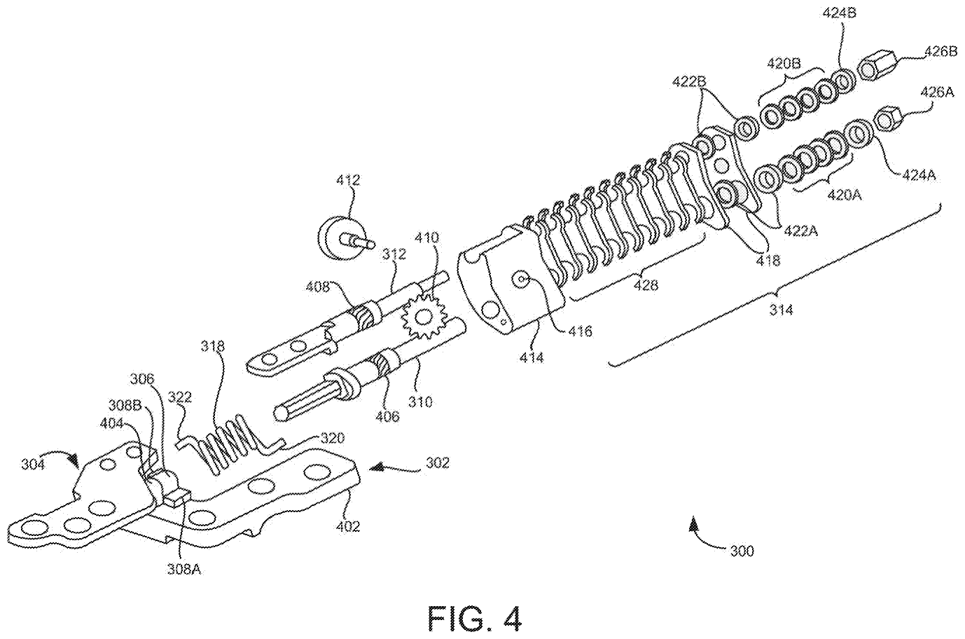

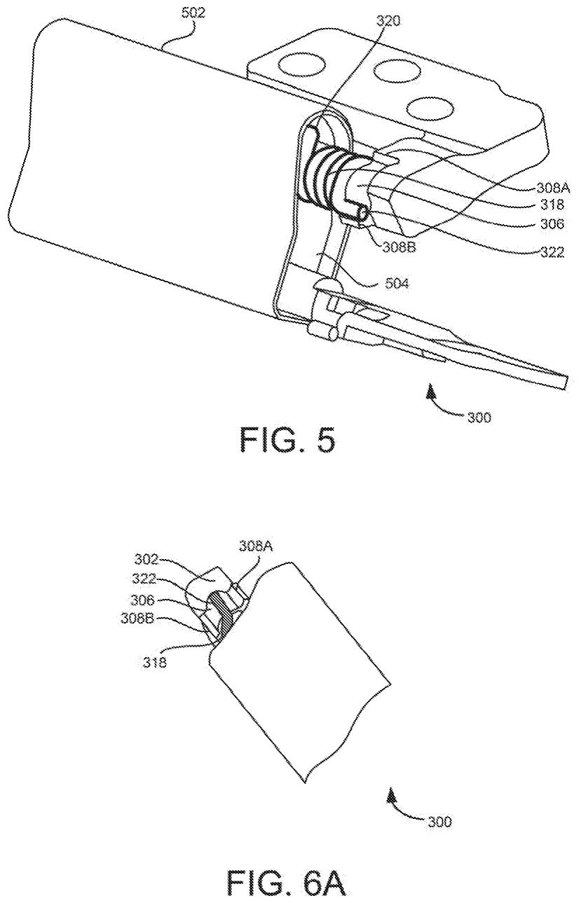

FIG. 5 is a side view of example dual-axis hinge assembly 300 of FIG. 3. For example, similarly named elements of FIG. 5 may be similar in structure and/or function to elements described with respect to FIG. 3. As shown in FIG. 5 hinge assembly 300 may include a casing 502 and a side wall 504. In one example, casing 502 may be formed by a hinge cap and a pair of hinge brackets (e.g., side walls) connected to the hinge cap at both sides. In the example shown in FIG. 5, fixed end 320 may be fixedly connected to side wall 504 while movable end 322 may be positioned in recess portion 306. An example operation of elastic member 318 in the energy storage state and the free state at different hinge angles of rotation is described in FIGS. 6A to 6D.

FIGS. 6A to 6D are schematic views of example dual-axis hinge assembly 300 of FIG. 3, illustrating an example operation of elastic member 318 at different angles of rotation. In one example, first bracket 302 may include recess portion 306, first edge 308A, and second edge 308B. During operation, elastic member 318 may be in a free state or in an energy storage state based on different angles of rotation between first bracket 302 and second bracket 304.

At 120 degrees as shown in FIG. 6A, movable end 322 of elastic member 318 may be positioned in recess portion 306. In this case, elastic member 318 may be in the free state. When first bracket 302 is rotated from 120 degrees to 90 degrees as shown in FIG. 6B and from 90 degrees to 30 degrees as shown in FIG. 6C, movable end 322 may slide on recess portion 306 of first bracket 302. In this example, elastic member 318 may be in the free state. At 30 degrees as shown in FIG. 6C, movable end 322 may begin to contact with second edge 308B of first bracket 302 and elastic member 318 may start to compress. When first bracket 302 is rotated from 30 degrees to 0 degrees as shown in FIG. 6D, second edge 308B may push movable end 322 such that elastic member 318 may get compressed to store potential energy. Thus, from 30 degrees to 0 degrees, elastic member 318 may be in the energy storage state. In one example, when the electronic device is being opened from 0 degrees to 30 degrees, the potential energy may be converted into kinetic energy. Thus, elastic member 318 may generate an opening force, and hence opening of the electronic device may become light.

Similarly, when first bracket 302 is rotated from 30 degrees to 330 degrees, movable end 322 may slide on recess portion 306 of first bracket 302. In this example, elastic member 318 may be in the free state. At 330 degrees, movable end 322 may begin to contact with first edge 308A of first bracket 302 and elastic member 318 may start to compress. When the first housing is rotated from 330 degrees to 360 degrees, first edge 308A may push movable end 322 such that elastic member 318 may get compressed to store potential energy, which can be converted into kinetic energy during rotation of the first housing from 360 to 330 degrees. Thus, elastic member 318 may be free while moving on recess portion 306 and elastic member 318 may be compressed when the elastic member 318 engages with any edge (e.g., first edge 308A or second edge 308B). In one example, working angle of elastic member 318 may be controlled by changing a location of first edge 308A and/or second edge 308B.

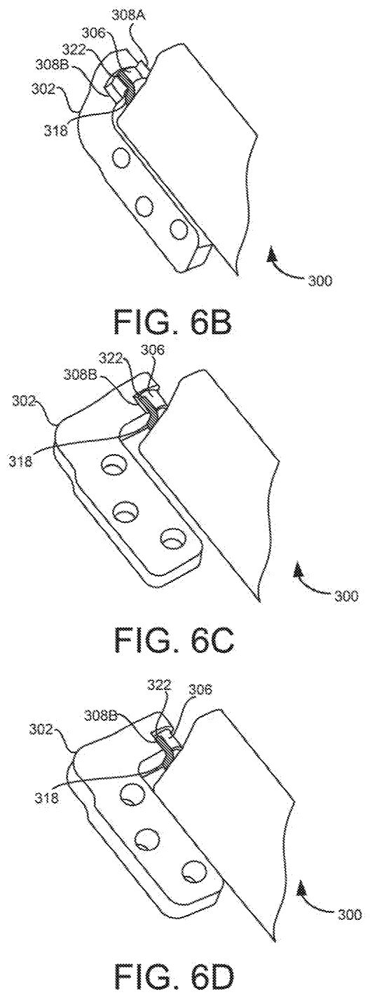

FIG. 7 is an example graph 700 depicting an overall torque of hinge assembly 300 of FIG. 3 at particular angles of rotation. The overall torque may include torque generated by torque engine 314 and elastic member 318. As shown in graph 700, during closing of first housing from 30 to 0 degrees, elastic member 318 may be converted from a free state to an energy storage state and hence dual-axis hinge assembly 300 may generate an overall torque T1 (e.g., as shown by plot 702). In this case, torque required to rotate the first housing from 30 to 0 degrees is increased. Further, during the opening of the first housing from 0 to 30 degrees, elastic member 318 may release energy and hence dual-axis hinge assembly 300 may generate an overall torque T2, T2<T1 (e.g., as shown by plot 704). In this case, torque required to rotate the first housing from 0 to 30 degrees is reduced due to torque distribution of elastic member 318.

Similarly, during opening of first housing from 330 to 360 degrees, elastic member 318 may be converted from a free state to an energy storage state and hence dual-axis hinge assembly 300 may generate an overall torque T1 (e.g., as shown by plot 704). Further, during the closing of the first housing from 360 to 330 degrees, elastic member 318 may release energy and hence dual-axis hinge assembly 300 may generate an overall torque T2, T2<T1 (e.g., as shown by plot 702). Further, elastic member 318 may be in a free state when the first housing is rotated between 30-330 degrees.

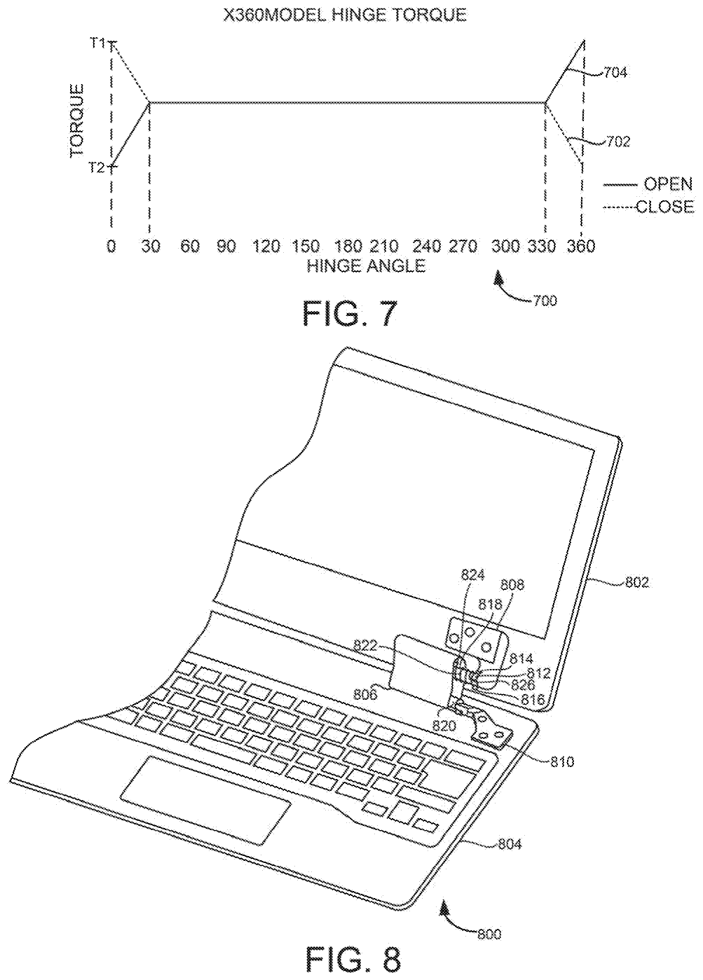

FIG. 8 is a perspective view of a portion of an example electronic device 800 including an example hinge assembly 806. Electronic device 800 may include a first housing 802, a second housing 804, and hinge assembly 806 to pivotally connect first housing 802 and second housing 804. Example electronic device 800 may be a computing system, for example, a laptop, a convertible device, a PDA, a notebook, a sub-notebook, a personal gaming device, or other computing device with first housing 802 closeable onto second housing 804. Example convertible device may refer to a device that can be “converted” from a laptop mode to a tablet mode. In the tablet mode, first housing 802 may be closed with a display facing up and viewable, i.e., first housing 802 may be substantially parallel to and adjacent to second housing 804.

For example, second housing 804 may house a keyboard, a battery, a touchpad, and so on First housing 802 may house a display (e.g., a touchscreen display). Example display may include liquid crystal display (LCD), light emitting diode (LED), electro-luminescent (EL) display, or the like. Electronic device 800 may be equipped with other components such as a camera, audio/video devices, and the like, depending on the functions of electronic device 800.

As shown in FIG. 8, hinge assembly 806 may be pivotally connected to first housing 802 and second housing 804. For example, hinge assembly 806 may allow first housing 802 to rotate in directions about the pivot axes relative to second housing 804. Example hinge assembly 806 may include a first bracket 808 and a second bracket 810 fixedly engaged with first housing 802 and second housing 804, respectively. In one example, first bracket 808 may include a first recess portion 812 between a first edge 814 and a second edge 816. Further, hinge assembly 806 may include a first shaft 818 and a second shaft 820 coupled to first bracket 808 and second bracket 810, respectively.

Furthermore, hinge assembly 806 may include a first elastic member 822 rotatably mounted on first shaft 818. For example, first shaft 818 may rotate relative to first elastic member 822. Example first elastic member 822 may include a fixed end 824 and a movable end 826 extended into first recess portion 812. In one example, movable end 826 may slide along a surface of first recess portion 812 during rotation of first housing 802 in a first angle range and to engage with first edge 814 or second edge 816 to generate a torsional force during rotation of first housing 802 in a second angle range.

For example, the first angle range may be in a range of about 30 to 330 degrees and the second angle range may be in a range of about 0 to 30 degrees or 330 to 360 degrees. In one example, first elastic member 822 may be converted from a free state to an energy storage state via torsion of first elastic member 822 during a first rotational direction of first housing 802 from 30 to 0 degrees or a second rotational direction of first housing from 330 to 360 degrees. Further, first elastic member 822 may be converted from the energy storage state to the free state via release of first elastic member 822 during the second rotational direction of first housing 802 from 0 to 30 degrees or the first rotational direction of first housing 802 from 360 to 330 degrees.

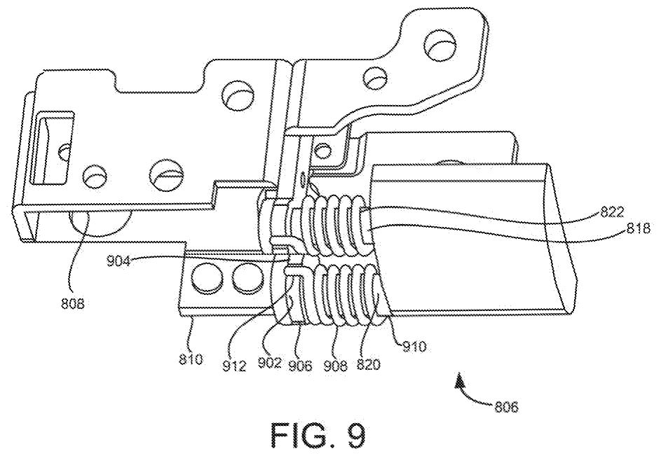

FIG. 9 is a schematic view of example hinge assembly 806 of FIG. 8, depicting additional features. For example similarly named elements of FIG. 9 may be similar in structure and/or function to elements described with respect to FIG. 8. As shown in FIG. 9, hinge, assembly 806 may include two elastic members (e.g., first elastic member 822 and a second elastic member 908) corresponding to two rotating shafts (e.g., first shaft 818 and second shaft 820), respectively. For example, first elastic member 822 may be mounted on first shaft 818 and second elastic member 908 may be mounted on second shaft 820. Further, first shaft 818 and second shaft 820 may be coupled to first bracket 808 and second bracket 810, respectively. Example second bracket 810 may include a second recess portion 902 between a third edge 904 and a fourth edge 906.

In one example, second elastic member 908 may include a fixed end 910 and a movable end 912 extended into second recess portion 902. During operation, movable end 912 may slide along a surface of second recess portion 902 during rotation of a first housing in the first angle, range arid to engage with the third edge 904 or fourth edge 906 to generate a torsional force during rotation of the first housing in the second angle range. Thus, first elastic member 822 and second elastic member 908 may store and release energy at a same time to provide the opening force at specific angles (i.e., 0 to 30 degrees and 360 to 330 degrees).

Even though the hinge assembly of FIGS. 1A-9 depicts an example elastic member with a fixed end connected to a support structure and a movable end disposed on a first bracket, the hinge assembly may also be designed to have the fixed end on the first bracket and the movable end on the support structure such that the elastic member may be in an energy storage at predefined angles during rotation of the first bracket relative to a second bracket. In some examples, support structure 102 of FIG. 1A may be a casing of hinge component (e.g., a synchronous gear unit, a torque engine, or the like), a casing of the hinge assembly, or any other stationary structure to hold the fixed end.

It may be noted that the above-described examples of the present solution are for the purpose of illustration only. Although the solution has been described in conjunction with a specific embodiment thereof, numerous modifications may be possible without materially departing from the teachings and advantages of the subject matter described herein. Other substitutions, modifications and changes may be made without departing from the spirit of the present solution. All of the features disclosed in this specification (including any accompanying claims, abstract and drawings), and/or all of the steps of any method or process so disclosed, may be combined in any combination, except combinations where at least some of such features and/or steps are mutually exclusive.

The terms include, “have,” and variations thereof, as used herein, have the same meaning as the term “comprise” or appropriate variation thereof. Furthermore, the term “based on,” as used herein, means “based at least in part on.” Thus, a feature that is described as based on some stimulus can be based on the stimulus or a combination of stimuli including the stimulus.

The present description has been shown and described with reference to the foregoing examples. It is understood, however, that other forms, details, and examples can be made without departing from the spirit and scope of the present subject matter that is defined in the following claims.

What is claimed is:

1. A hinge assembly comprising:
a support structure;
a shaft received through the support structure;
a torque mechanism to apply a frictional torque to the shaft;
a first bracket and a second bracket, wherein the shaft is fixedly engaged with the first bracket to pivotably connect the first bracket to the second bracket, wherein the first bracket comprises a recess portion and an edge portion; and
an elastic member rotatably mounted on the shaft, wherein the elastic member comprises:
a first end fixed to the support structure; and
a second end positioned in the recess portion such that the elastic member is in a free state while moving in the recess portion and in an energy storage state when engages with the edge portion during rotation of the first bracket relative to the second bracket.

2. The hinge assembly of claim 1, wherein the first bracket comprises an adaptor portion to fixedly hold the shaft and a mounting portion to fixedly engage with a first housing of an electronic device, and wherein the recess portion and the edge portion are formed on an outer surface of the adaptor portion.

3. The hinge assembly of claim 1, wherein the elastic member is to apply a rotational torque to the shaft between a particular angle of rotation of the first bracket relative to the second bracket, wherein the particular angle of rotation corresponds to the energy storage state, and wherein the elastic member is a torsion spring.

4. The hinge assembly of claim 3, wherein the rotational torque is to add to the frictional torque in a first rotational direction of the first bracket and to resist the frictional torque in a second rotational direction of the first bracket, wherein the second rotational direction is opposite to the first rotational direction.

5. The hinge assembly of claim 3, wherein the particular angle of rotation is in a range of 0 to 30 degrees.

6. A dual-axis hinge assembly comprising:
first and second brackets to connect to first and second housings of an electronic device, respectively, wherein the first bracket includes a recess portion between first and second edges;
a first shaft coupled to the first bracket:
a second shaft coupled to the second bracket;
a torque engine connected to the first shaft and the second shaft;
a synchronous gear unit disposed between the first shaft and the second shaft; and
an elastic member rotatably mounted on the first shaft, wherein the elastic member comprises:
a fixed end; and
a movable end positioned in the recess portion, wherein the elastic member is in a free state while moving in the recess portion and in an energy storage state when engages with the first edge or the second edge during rotation of the first bracket relative to the second bracket.

7. The dual-axis hinge assembly of claim 6, wherein the first bracket comprise:
a mounting portion to fixedly engage with the first housing; and
an adaptor portion to fixedly hold the first shaft, wherein the recess portion is formed on an outer surface of the adaptor portion.

8. The dual-axis hinge assembly of claim 6, wherein the synchronous gear unit comprises:
a first guide threaded portion on the first shaft;
a second guide threaded portion on the second shaft;
an intermediate gear to engage with the first guide threaded portion and the second guide threaded portion to enable synchronous rotation between the first shaft and the second shaft in reverse directions; and
a gear holder to hold the intermediate gear such that the intermediate gear is to physically engage with the first guide threaded portion and the second guide threaded portion.

9. The dual-axis hinge assembly of claim 6, wherein the movable end is to engage with the first edge during dosing of the first bracket relative to the second bracket such that the elastic member is to generate a first spring torque to the dual-axis hinge assembly between a first angle range, and wherein the movable end is to engage with the second edge during opening of the first bracket relative to the second bracket such that the elastic member is to generate a second spring torque to the dual-axis hinge assembly between a second angle range.

10. The dual-axis hinge assembly of claim 9, wherein the first angle range is in a range of about 30 to 0 degrees and the second angle range is in a range of about 330 to 360 degrees.

11. An electronic device comprising:
first and second housings; and
a hinge assembly to pivotally connect the first and second housings, the hinge assembly comprising:
first and second brackets fixedly engaged with the first and second housings, respectively, wherein the first bracket comprises a first recess portion between first and second edges;
first and second shafts coupled to the first and second brackets respectively; and
a first elastic member rotatably counted n the first shaft, the first elastic member comprising:
a fixed end; and
a movable end extended into the first recess portion, wherein the movable end is to slide along a surface of the first recess portion during rotation of the first housing in a first angle range and to engage with the first or second edge to generate a torsional force during rotation of the first housing in a second angle range.

12. The electronic device of claim 11, wherein the first angle range is in a range of about 30 to 330 degrees and the second angle range is in a range of about 0 to 30 degrees or 330 to 360 degrees.

13. The electronic device of claim 12, wherein the first elastic member is converted from a free state to an energy storage state via torsion of the first elastic member during a first rotational direction of the first housing from 30 to 0 degrees or a second rotational direction of the first housing from 330 to 360 degrees, and wherein the first elastic member is converted from the energy storage state to the free state via release of the first elastic member during the second rotational direction of the first housing from 0 to 30 degrees or the first rotational direction of the first housing from 360 to 330 degrees.

14. The electronic device of claim 11, wherein the second bracket comprises a second recess portion between third and fourth edges.

15. The electronic device of claim 14, wherein the ne assembly further comprises:
a second elastic member mounted on the second shaft, wherein the second elastic member comprises:
a fixed end; and
a movable end extended into the second recess portion, wherein the movable end is to slide along a surface of the second recess portion during rotation of the first housing in the first angle range and to engage with the third or fourth edge to generate a torsional force during rotation of the first housing in the second angle range.
